(19) United States
(12) Patent Application Publication
(10) Pub. No.: US 2013/0028773 A1
(43) Pub. Date: Jan. 31, 2013

(54) APEX SEAL FOR ROTARY INTERNAL COMBUSTION ENGINE

(71) Applicants: Eugene GEKHT, Brossard (CA); Mike Fontaine, Boucherville (CA)

(72) Inventors: Eugene GEKHT, Brossard (CA); Mike Fontaine, Boucherville (CA)

(21) Appl. No.: 13/272,766

(22) Filed: Oct. 13, 2011

Related U.S. Application Data
(60) Provisional application No. 61/512,472, filed on Jul. 28, 2011.

(51) Int. Cl. F02B 55/00; F16J 15/34

(52) U.S. Cl. 418/61.2; 277/306

(57) ABSTRACT

A rotor of a rotary internal combustion engine including apex springs each being formed of a continuous band including first and second opposed end sections each contacting the inner surface of the apex seal adjacent to a respective one of the end faces, a respective intermediate section extending radially inwardly from each end section and contacting the outer surface of the groove along a respective contact zone, and a central section extending axially between the intermediate sections and having a portion extending radially outwardly from each of the intermediate sections, the central section extending out of contact with both the outer surface of the groove and the apex seal.

### CROSS-REFERENCE TO RELATED APPLICATION

This application claims priority on provisional U.S. application No. 61/512,472 filed Jul. 28, 2011, the entire contents of which are incorporated by reference herein.

### TECHNICAL FIELD

The application relates generally to an internal combustion engine using a rotary design to convert pressure into a rotating motion, more particularly, to a sealing arrangement for such an engine.

### BACKGROUND OF THE ART

Rotary engines such as the ones known as Wankel engines use the eccentric rotation of a piston to convert pressure into a rotating motion, instead of using reciprocating pistons. In these engines, the rotor includes a number of apex portions which remain in contact with a peripheral wall of the rotor cavity of the engine throughout the rotational motion of the rotor.

The space around the rotor within the rotor cavity defines a number of working chambers which must be sealed from one another in order for the engine to work efficiently. Prior art sealing arrangements typically have gaps between some of the adjacent seal members, which may be due to manufacturing tolerances and/or differential thermal expansions of the seal elements and rotor.

Arcuate leaf spring may be provided between each apex seal and the rotor surface, to bias the apex seal radially against the peripheral wall of the rotor cavity. However, such a leaf spring may have a tendency to rock, which may lead to increased gaps between the apex seals and the rotor walls.

### SUMMARY

In one aspect, there is provided a rotor of a rotary internal combustion engine, the rotor comprising a body having two axially spaced apart end faces, and a peripheral face extending between the end faces and defining three circumferentially spaced apex portions, each of the apex portion having at least one groove defined radially inwardly into the rotor body, each groove extending between the end faces, an apex seal received in each groove and protruding radially from the peripheral face of the rotor, and a spring within each groove located between an inner surface of the apex seal and an outer surface of the groove, the spring biasing the apex seal radially outwardly away from the peripheral surface, each spring being formed of a continuous band having first and second opposed ends with each end contacting the inner surface of the apex seal adjacent to a respective one of the end faces, a respective intermediate section extending radially inwardly from each end and contacting the outer surface of the groove along a respective contact zone, and a central section extending axially between the intermediate sections and having a portion extending radially outwardly from each of the intermediate sections, the central section extending out of contact with both the outer surface of the groove and the apex seal.

In another aspect, there is provided a rotary internal combustion engine comprising a stator body having an internal cavity defined by two axially spaced apart end walls and a peripheral wall extending between the end walls, the cavity having an epitrochoid shape defining two lobes, a rotor body having two axially spaced apart end faces each extending in proximity of a respective one of the end walls of the stator body, and a peripheral face extending between the end faces and defining three circumferentially spaced apex portions, the rotor body being engaged to an eccentric shaft to rotate within the cavity with each of the apex portions remaining adjacent the peripheral wall, and each of the apex portion having at least one apex seal extending between the end faces and protruding radially from the peripheral face, each apex seal being radially biased against the peripheral surface by a spring, each spring being formed of a continuous band having first and second opposed ends with each end contacting an inner surface of the apex seal adjacent to a respective one of the end faces, a respective intermediate section extending radially inwardly from each end and contacting a surface of the rotor body along a respective contact zone, and a central section extending axially between the intermediate sections and having a portion extending radially outwardly from each of the intermediate sections, the central section extending out of contact with both the outer surface of the groove and the apex seal.

In a further aspect, there is provided a method of sealing chambers of a Wankel engine between apex portions of a rotor of the engine and a peripheral wall of a rotor cavity of a body of the engine, the method comprising biasing at least one apex seal member from each of the apex portions radially against the peripheral wall by using a spring to simultaneously push radially outwardly on the apex seal member in only two axially spaced apart locations and push radially inwardly against a surface of the rotor in only two axially spaced apart zones both located between the two spaced apart locations.

### DESCRIPTION OF THE DRAWINGS

Reference is now made to the accompanying figures in which:

FIG. 1 is a schematic cross-sectional view of a rotary internal combustion engine;

FIG. 2 is a schematic cross-sectional view of an apex portion of the rotor of an engine such as shown in FIG. 1, in accordance with one embodiment;

FIG. 3 is a schematic cross-sectional view of an apex portion of the rotor of an engine such as shown in FIG. 1, in accordance with an alternate embodiment; and

FIG. 4 is a schematic cross-sectional view of an apex portion of the rotor of an engine such as shown in FIG. 1, in accordance with another alternate embodiment.

### DETAILED DESCRIPTION

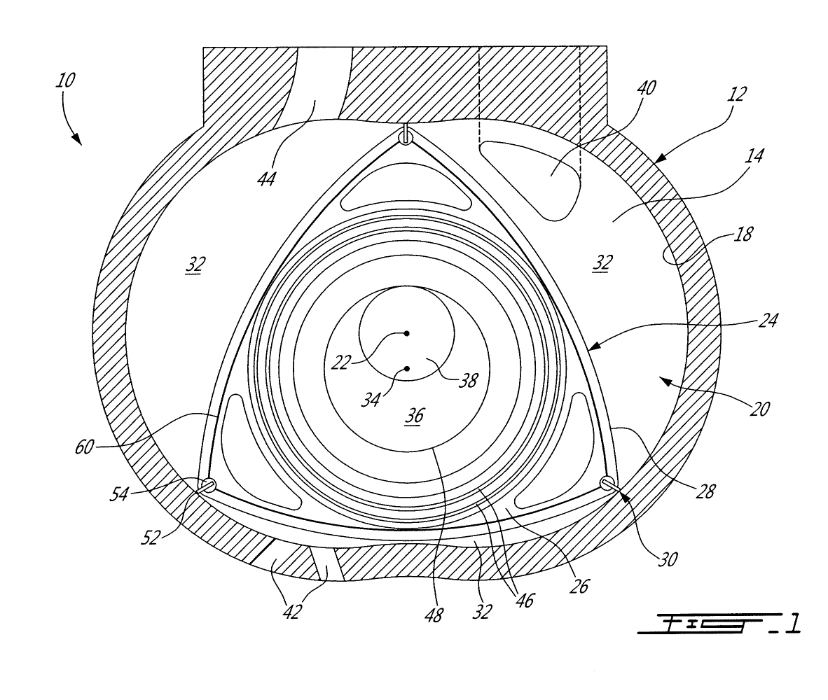

Referring to FIG. 1, a rotary internal combustion engine 10 known as a Wankel engine is schematically shown. The engine 10 comprises an outer body 12 having axially-spaced end walls 14 with a peripheral wall 18 extending therebetween to form a rotor cavity 20. The inner surface of the peripheral wall 18 of the cavity 20 has a profile defining two lobes, which is preferably an epitrochoid.

An inner body or rotor 24 is received within the cavity 20. The rotor 24 has axially spaced end faces 26 adjacent to the outer body end walls 14, and a peripheral face 28 extending therebetween. The peripheral face 28 defines three circumferentially-spaced apex portions 30, and a generally triangular profile with outwardly arched sides. As will be detailed further below, the apex portions 30 are in sealing engagement with the inner surface of peripheral wall 18 to form three working chambers 32 between the inner rotor 24 and outer body 12. The geometrical axis 34 of the rotor 24 is offset from and parallel to the axis 22 of the outer body 12.

In the embodiment shown, the outer body 12 is stationary while the rotor 24 is journaled on an eccentric portion 36 of a shaft 38, the shaft 38 being co-axial with the geometrical axis 22 of the cavity 20. Upon rotation of the rotor 24 relative to the outer body 12 the working chambers 32 vary in volume. An intake port 40 is provided through one of the end walls 14 for admitting air, or air and fuel, into one of the working chambers 32. Passages 42 for a spark plug or other ignition mechanism, as well as for one or more fuel injectors (not shown) are provided through the peripheral wall 18. An exhaust port 44 is also provided through the peripheral wall 18 for discharge of the exhaust gases from the working chambers 32. Alternately, the exhaust port 44 and/or the passages 42 may be provided through the end wall 14, and/or the intake port 40 may be provided through the peripheral wall 18.

During engine operation the working chambers 32 have a cycle of operation including the four phases of intake, compression, expansion and exhaust, these phases being similar to the strokes in a reciprocating-type internal combustion engine having a four-stroke cycle.

At least one oil seal ring 46 is disposed in a circular groove in each end face 26 of the rotor between the bearing 48 for the rotor 24 on the shaft eccentric 36 and the face seals. Each oil seal 46 impedes leakage flow of lubricating oil radially outwardly thereof between the respective rotor end face 26 and outer body end wall 14. Suitable springs (not shown) are provided for urging each oil seal 46 axially into contact with the adjacent end wall 14 of the outer body 12.

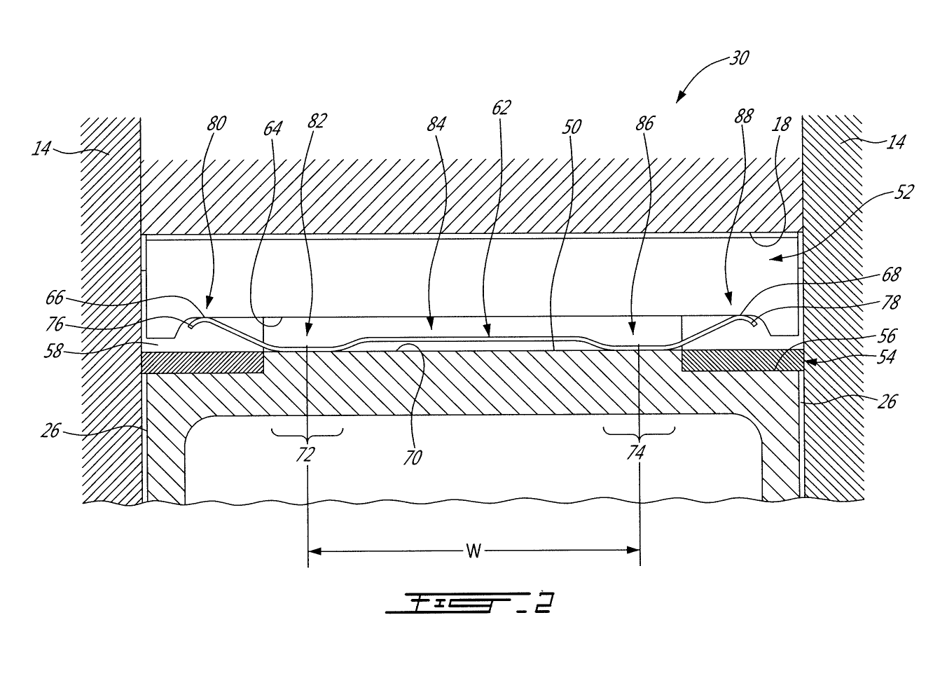

The working chambers 32 are sealed by apex seals, face seals and end seals. Referring to FIG. 2, each rotor apex portion 30 has a groove defined therein and extending radially inwardly into the rotor body 24, from one end face 26 to the other. An apex seal 52 is received within each groove 50, and protrudes radially from the peripheral face 28. In a particular embodiment, each apex seal 52 extends axially beyond both end faces 26, and has an axial dimension which is as close as possible to a distance between the two end walls 14 of the cavity 20, taking into consideration the difference in thermal expansion between the material(s) of the outer body 12 and the material of the apex seal 52, which in a particular embodiment is made of a suitable type of ceramic. In the embodiment shown in FIG. 2, each apex seal 52 is monolithic, i.e. is formed of a single seal member.

An end seal 54 is received within a respective cylindrical recess 56 defined at each end of the groove 50. Each end seal 54 has a radial slot 58 defined therein, which receives the respective end of the apex seal 52. Each end seal 54 is biased against the respective end wall 14 through a suitable spring (not shown).

Referring back to FIG. 1, each end face 26 of the rotor 24 has a plurality of grooves defined therein running from each apex portion 30 to each adjacent apex portion 30, with a face seal 60 being received within each groove. In a particular embodiment, each face seal 60 is monolithic. Each end face groove and corresponding face seal 60 are arc-shaped and disposed adjacent to but inwardly of the rotor periphery throughout their length. A spring (not shown) located behind each face seal 60 urges it axially outwardly so that the face seal 60 projects axially away from the adjacent rotor end face 26 into sealing engagement with the adjacent end wall 14 of the cavity. Each face seal 60 is in sealing engagement with the end seal 54 adjacent each end thereof, for example by being received in a corresponding groove (not shown) defined in the end seal 54, or through abutment therewith. The end seals 54, face seals 60 and apex seals 52 thus cooperate to form a seal against the respective end wall 14 and its junction with the peripheral wall 18.

Referring to FIG. 2, each groove 50 receives a spring 62, located between an inner surface 64 of the corresponding apex seal 52 and the outer surface 70 of the groove 50. The spring 62 pushes the apex seal 52 radially outwardly away from the peripheral face 28 of the rotor 24 and against the peripheral wall 18 of the cavity 20. In the embodiment shown, the inner surface 64 receives the spring 62 in an indentation thereof. Other geometries are alternately possible.

The spring contacts the axially extending inner surface 64 of the apex seal 52 in two spaced apart locations 66, 68, and contacts the outer surface 70 of the groove 50 along two spaced apart contact zones 72, 74 defined between these two locations 66, 68. In the embodiment shown, the spring 62 contacts the apex seal 52 only along its inner surface 64, and provides a biasing force which is directed only radially.

The spring 62 is a continuous band with two end sections 80, 88 each defined by a respective one of the opposed ends 76, 78. The ends 76, 78 or end sections 80, 88 each contact the inner surface 64 of the apex seal 52 at their respective location 66, 68 which is defined in proximity to a respective one of the end faces 26. An intermediate section 82, 86 extends radially inwardly from each end 76, 78 and contacts the outer surface 70 of the groove 50 along the respective contact zone 72, 74. A central section 84 extends axially between the intermediate sections 82, 86 with a portion extending radially outwardly from each of the intermediate sections 82, 86. The central section 84 extends without contacting the outer surface 70 of the groove 50 and without contacting the apex seal 52.

In a particular embodiment, the spring 62 is made of a suitable metal, for example steel or a suitable type of super alloy such as, for example, A-286 or Inconel® 750.

It can be seen that the two ends 76, 78 of the spring 62 curve away from the inner surface 64 of the apex seal 52. As such, the portions of the spring 62 contacting the apex seal 52 are rounded to minimize sharp edge contact with the apex seal 52 and as such reduce the risk of damage to the apex seal 52, particularly in cases where the apex seal 52 is made of ceramic. The size of the two locations 66, 68 of contact between the spring 62 and apex seal 52 is also minimized, which may advantageously reduce wear of the apex seal 52, for example through axial friction.

The spring 62 has a relatively large wheel base W, defined as the distance between the center of the first and second contact zones 72, 74. In a particular embodiment, the wheel base W extends along between 55% and 75% of a total length of the spring. A larger wheel base W may increase the stability of the spring 62 and reduce the risks of rocking of the apex seal 52 for an improved seal.

The spaced apart contact zones 72, 74 created by the length of the central section 84 which extends out of contact with the seal 52 and groove surface 70 create a relatively wide wheel base, which may help reduce axial friction and wear, and rocking motion of the spring. In the embodiment shown, the central section 84 is longer than the combined length of the two contact zones 72, 74.

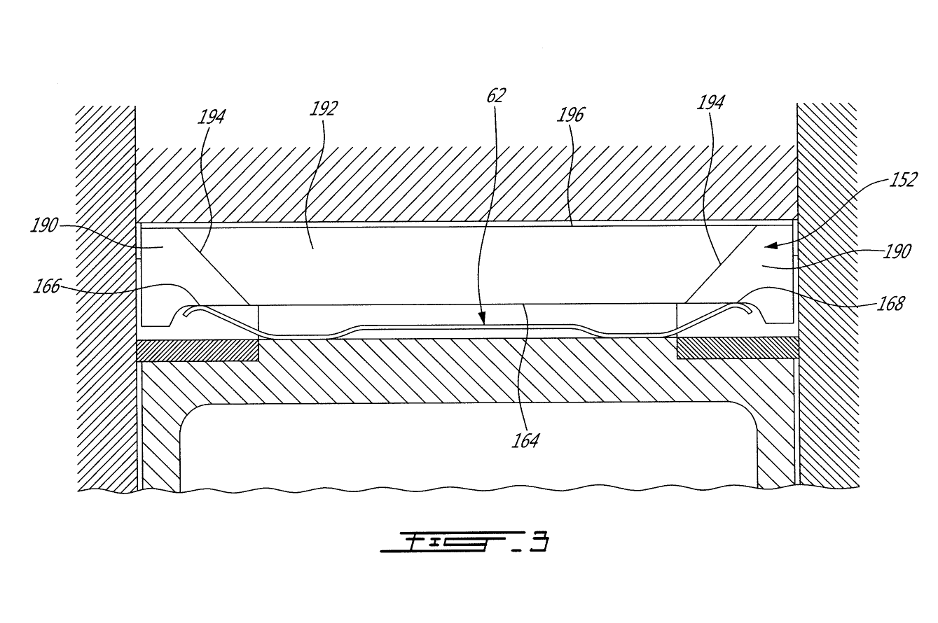

Referring to FIG. 3, another embodiment is shown, where the spring 62 is shown as used with an apex seal 152 including three separate seal members, namely a central seal member 192 located between two side seal member 190. The central seal member 192 is in contact with each of the side seal members 190 through complementary angled surfaces 194. The inner surface 164 of the apex seal 152 is partly defined by each side seal member 190, and the spring 62 contacts the inner surface 164 within each of the side seal members 190. In other words, the locations 166, 168 of contact between the inner surface 164 and spring 62 are each defined in a respective one of the side seal members 190.

The angled surfaces 194 transfer the radial biasing force applied to the side seal members 190 to the central seal member 192. The side and central and seal members 190, 192 are complementary to define an apex seal 152 having a substantially rectangular shape, with each seal member 190, 192 defining a part of the outer surface 196 of the seal 152. In other words, the angled surfaces 194 extend from the inner surface 164 to the outer surface 196.

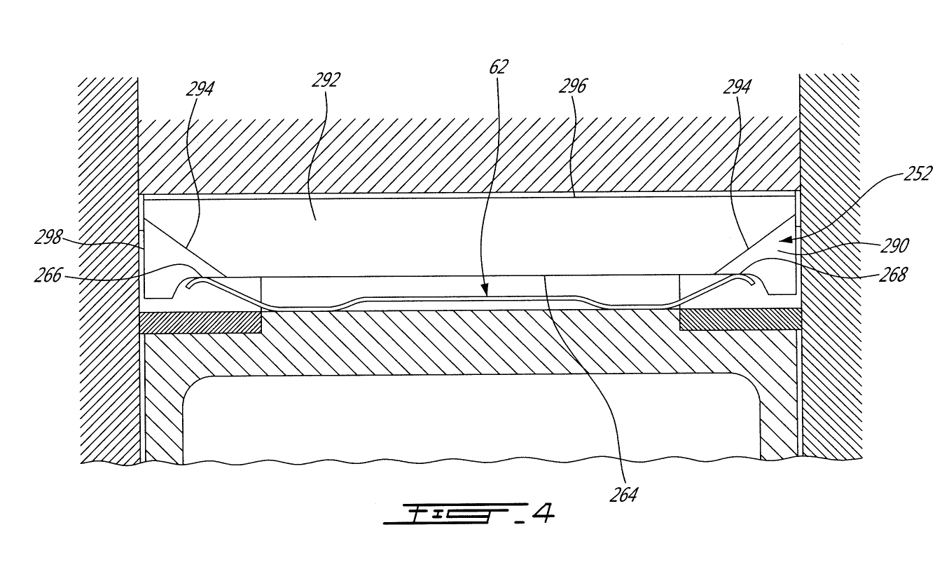

Referring to FIG. 4, in another embodiment, the spring 62 is shown as used with an apex seal 252 also including three separate seal members, namely a central seal member 292 and two side seal member 290 in contact with the central seal member 292 through complementary angled surfaces 294. Again the spring 62 contacts the inner surface 264 within each of the side seal members 290, i.e. the locations 266, 268 of contact between the inner surface 264 and spring 62 are each defined in a respective one of the side seal members 290.

In this embodiment, the side and central and seal members 290, 292 are complementary to define an apex seal 252 having a substantially rectangular shape, with the outer surface 296 of the seal 252 being completely defined by the central seal member 292. In other words, the angled surfaces 294 extend from the inner surface 264 to a respective end surface 298 of the seal 252.

In another embodiment with is not shown, each apex portion includes more than one apex seal, each biased through a respective spring 62.

The above description is meant to be exemplary only, and one skilled in the art will recognize that changes may be made to the embodiments described without departing from the scope of the invention disclosed. For example, any suitable material may be employed. The spring may have any suitable shape performing the functions described. The general configuration described may be augmented with other features or sections provided on such spring. Therefore, modifications which fall within the scope of the present invention will be apparent to those skilled in the art, in light of a review of this disclosure, and such modifications are intended to fall within the appended claims.

1. A rotor of a rotary internal combustion engine, the rotor comprising:
a body having two axially spaced apart end faces, and a peripheral face extending between the end faces and defining three circumferentially spaced apex portions, each of the apex portion having at least one groove defined radially inwardly into the rotor body, each groove extending between the end faces;
an apex seal received in each groove and protruding radially from the peripheral face of the rotor; and
a spring within each groove located between an inner surface of the apex seal and an outer surface of the groove, the spring biasing the apex seal radially outwardly away from the peripheral surface, each spring being formed of a continuous band having:
first and second opposed end sections with each end section contacting the inner surface of the apex seal adjacent to a respective one of the end faces,
a respective intermediate section extending radially inwardly from each end section and contacting the outer surface of the groove along a respective contact zone, and
a central section extending axially between the intermediate sections and having a portion extending radially outwardly from each of the intermediate sections, the central section extending out of contact with both the outer surface of the groove and the apex seal.

2. The rotor as defined in claim 1, wherein opposed ends of the spring curve away from the inner surface.

3. The rotor as defined in claim 1, wherein a length of the central section is greater than a combined length of the contact zones.

4. The rotor as defined in claim 1, wherein a wheel base of the spring defined between mid-points of the contact zones is between 55% and 75% of a total length of the spring.

5. The rotor as defined in claim 1, wherein the spring contacts the apex seal only along the inner surface thereof.

6. The rotor as defined in claim 1, wherein the apex seal is monolithic.

7. The rotor as defined in claim 1, wherein the apex seal includes a first side seal member adjacent the first end face, a second side seal member adjacent the second end face, and a central seal member extending axially therebetween, the central seal member being in contact with each of the side seal members through complementary angled surfaces, each side seal member having an inner surface defining a respective part of the inner surface of the apex seal, and each end section of the spring contacts the inner surface of a respective one of the side seal members.

8. The rotor as defined in claim 1, wherein the spring is made of metal and the apex seal is made of ceramic.

9. A rotary internal combustion engine comprising:
a stator body having an internal cavity defined by two axially spaced apart end walls and a peripheral wall extending between the end walls, the cavity having an epitrochoid shape defining two lobes;
a rotor body having two axially spaced apart end faces each extending in proximity of a respective one of the end walls of the stator body, and a peripheral face extending between the end faces and defining three circumferentially spaced apex portions, the rotor body being engaged to an eccentric shaft to rotate within the cavity with each of the apex portions remaining adjacent the peripheral wall; and
each of the apex portion having at least one apex seal extending between the end faces and protruding radially from the peripheral face, each apex seal being radially biased against the peripheral surface by a spring, each spring being formed of a continuous band having:
first and second opposed end sections with each end section contacting an inner surface of the apex seal adjacent to a respective one of the end faces,
a respective intermediate section extending radially inwardly from each end section and contacting a surface of the rotor body along a respective contact zone, and
a central section extending axially between the intermediate sections and having a portion extending radially outwardly from each of the intermediate sections, the central section extending out of contact with both the outer surface of the groove and the apex seal.

10. The engine as defined in claim 9, wherein opposed ends of the spring curve away from the inner surface.

11. The engine as defined in claim 9, wherein a length of the central section is greater than a combined length of the contact zones.

12. The engine as defined in claim 9, wherein a wheel base of the spring defined between mid-points of the contact zones is between 55% and 75% of a total length of the spring.

13. The engine as defined in claim 9, wherein the spring contacts the apex seal only along the inner surface thereof.

14. The engine as defined in claim 9, wherein the apex seal is monolithic.

15. The engine as defined in claim 9, wherein the apex seal includes a first side seal member adjacent the first end face, a second side seal member adjacent the second end face, and a central seal member extending axially therebetween, the central seal member being in contact with each of the side seal members through complementary angled surfaces, each side seal member having an inner surface defining a respective part of the inner surface of the apex seal, and each end section of the spring contacts the inner surface of a respective one of the side seal members.

16. The engine as defined in claim 9, wherein the spring is made of metal and the apex seal is made of ceramic.

17. A method of sealing chambers of a Wankel engine between apex portions of a rotor of the engine and a peripheral wall of a rotor cavity of a body of the engine, the method comprising biasing at least one apex seal member from each of the apex portions radially against the peripheral wall by using a spring to simultaneously push radially outwardly on the apex seal member in only two axially spaced apart locations and push radially inwardly against a surface of the rotor in only two axially spaced apart zones both located between the two spaced apart locations.

18. The method as defined in claim 17, wherein a distance between a mid-point of each of the two spaced apart zones is between 55% and 75% of a distance between the two spaced apart locations.
